(19) United States
(12) Patent Application Publication
(10) Pub. No.: US 2017/0113505 A1
(43) Pub. Date: Apr. 27, 2017

(54) VEHICLE BODY STRUCTURE HAVING SHOCK ABSORBER MOUNTING STRUCTURE

(71) Applicant: Kia Motors Corporation, Seoul (KR)

(72) Inventor: Hyung Gyu Park, Bucheon (KR)

(21) Appl. No.: 15/182,008

(22) Filed: Jun. 14, 2016

(30) Foreign Application Priority Data
Oct. 21, 2015 (KR) 10-2015-0146795

(51) Int. Cl. B60G 13/00; B62D 21/11

(52) U.S. Cl. CPC B60G 13/003; B62D 21/11

(57) ABSTRACT

A vehicle body structure having a shock absorber mounting structure is provided. The shock absorber mounting structure includes a first vehicle body member formed with a mounting aperture that corresponds to a shock absorber of a suspension. A shock absorber mounting bracket is coupled to the first vehicle body member that corresponds to the mounting aperture and has a side where the upper end portion of the shock absorber is configured to be engaged during penetrated. A second vehicle body member is coupled with the exterior edge portion of the first vehicle body member and extends in the upper side. An interior MBR bracket has a first side coupled to the interior surface of the second vehicle body member and a second side coupled to the upper surface of the first vehicle body member and forms a cross-sectional cubic space along with the first and second vehicle body members.

### CROSS-REFERENCE TO RELATED APPLICATION

This application claims priority to and the benefit of Korean Patent Application No. 10-2015-0146795 filed in the Korean Intellectual Property Office on Oct. 21, 2015, the entire contents of which are incorporated herein by reference.

### BACKGROUND

(a) Field of the Invention

The present invention relates to a vehicle body structure having a shock absorber mounting structure that improves rigidity and durability of a vehicle body mounted with a shock absorber and reduces weight and cost of a striker connected to a seat.

(b) Description of the Related Art

Generally, in a small vehicle, uses a rear shock absorber (RRS/ABS) of a two panel bush type. In this structure, since the two panel bush must be assembled within the vehicle, the structure must be maintained during the assemble property in a particular layout around the two panel bush. To date, in view of the layout limitations a member (MBR) type bracket to reinforce rigidity and durability has not been applied at an upper end of the RRS/ABS in the small vehicle. Additionally, the layout problems in a rear seat striker require a hammered striker component of a bolting assemble type to be used, and the cost and the weight increases.

FIG. 1 is a partial perspective view of a vehicle body structure having a general shock absorber mounting structure according to the related art, and FIG. 2 is a partial cross-sectional view of a vehicle body structure having a general shock absorber mounting structure according to the related art. Referring to the drawings, the vehicle body structure includes a vehicle body 100, a reinforcement bracket 105, a shock absorber mounting bracket 110, a striker reinforcing member 115, and a retractor bracket 120. The striker reinforcing member 115 is a component that reinforces the striker 205 connected to the seat, the retractor bracket 120 is a component connected to the retractor rolling a safe belt, the shock absorber mounting bracket 110 is a component mounted with a shock absorber 300 for a suspension, and the reinforcement bracket 105 is a component that improves the durability and the rigidity of the vehicle body around the shock absorber mounting bracket 110. However, as described above, the MBR type bracket used to reinforce the rigidity and the durability may be applied at the upper end of the RRS/ABS. Accordingly, due to the layout of the rear seat striker, the hammered striker portion of the bolting assemble type is required and the cost and the weight are increased.

The above information disclosed in this section is merely for enhancement of understanding of the background of the invention and therefore it may contain information that does not form the prior art that is already known in this country to a person of ordinary skill in the art.

### SUMMARY

The present invention provides a vehicle body structure with a shock absorber mounting structure by applying a reinforcement bracket of a MBR type to reinforce the rigidity and the durability of the vehicle body around the shock absorber and uses a seat striker of reduced cost and minimal weight.

A vehicle body structure having a shock absorber mounting structure according to an exemplary embodiment of the present invention may include a first vehicle body member formed with a mounting aperture that corresponds to a shock absorber of a suspension. A shock absorber mounting bracket may be coupled to the first vehicle body member by corresponding to the mounting aperture and may include one side where the upper end portion of the shock absorber may be engaged while being penetrated. A second vehicle body member may be coupled with the exterior edge portion of the first vehicle body member and may extend in the upper side. An interior MBR bracket may have a first side coupled to the interior surface of the second vehicle body member and a second side coupled to the upper surface of the first vehicle body member and may form a cross-sectional box space along with the first and second vehicle body members.

A striker connected to a seat may be bonded to the exterior surface of the interior MBR bracket. The striker may be a wire type of a circular cross sectional with a predetermined exterior diameter. A groove that corresponds to the exterior circumference of the striker may be formed on the exterior of the interior MBR bracket, and the portion of the striker may be inserted within the groove.

In some exemplary embodiments, a plurality of portions of the striker may be coupled to the interior MBR bracket. A first portion may be coupled to the upper side of the interior MBR bracket, and second portion may be coupled to the interior surface side of the interior MBR bracket. The exterior surface may be coupled to the interior surface of the second vehicle body member in the upper side of the interior MBR bracket. Further, the interior surface may be coupled to the retractor bracket connected to the safety belt.

The lower end portion of the interior MBR bracket may be bent within the vehicle body and the upper surface of the first vehicle body member may be coupled to lower end portion. The upper surface external to the vehicle body of the shock absorber mounting bracket may be bonded to the lower surface of the first vehicle body member. A plurality of members of the interior MBR bracket, the first vehicle body member, and the shock absorber mounting bracket may be overlapped and bonded.

### BRIEF DESCRIPTION OF THE DRAWINGS

The above and other objects, features and other advantages of the present invention will be more clearly understood from the following detailed description when taken in conjunction with the accompanying drawings:

FIG. 1 is an exemplary partial view of a vehicle body structure having a general shock absorber mounting structure according to the related art;

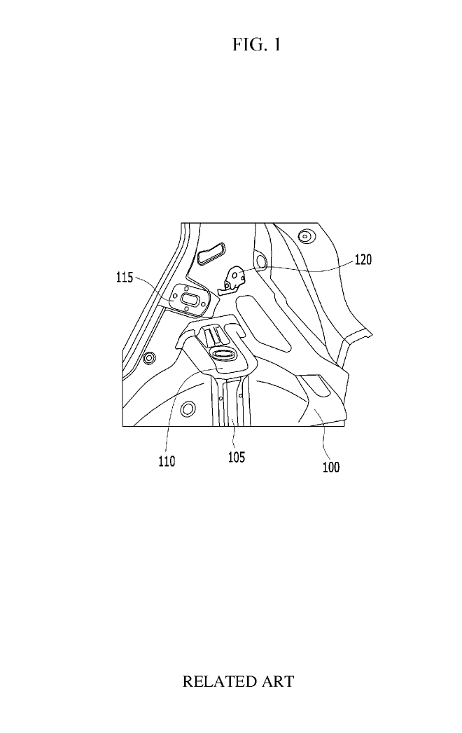

FIG. 2 is an exemplary partial view of a vehicle body structure having a general shock absorber mounting structure according to the related art;

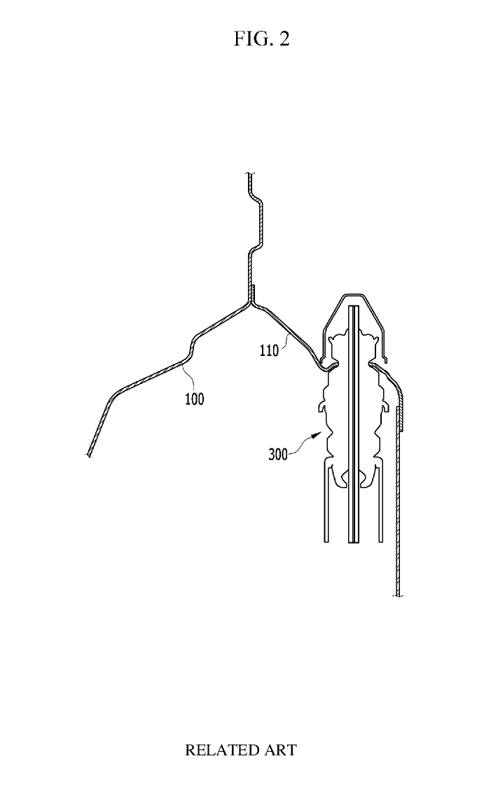

FIG. 3 is an exemplary partial view of a vehicle body structure having a shock absorber mounting structure according to an exemplary embodiment of the present invention;

FIG. 4 is an exemplary partial view of a vehicle body structure having a shock absorber mounting structure according to an exemplary embodiment of the present invention; and

FIG. 5 is an exemplary partial view of a vehicle body structure having a shock absorber mounting structure according to an exemplary embodiment of the present invention.

### DETAILED DESCRIPTION

Hereinafter, exemplary embodiments of the present invention will be described with reference to the accompanying drawings. In the following detailed description, only certain exemplary embodiments of the present invention have been shown and described, simply by way of illustration. As those skilled in the art would realize, the described embodiments may be modified in various different ways, all without departing from the spirit or scope of the present invention.

It is understood that the term “vehicle” or “vehicular” or other similar term as used herein is inclusive of motor vehicle in general such as passenger automobiles including sports utility vehicles (SUV), buses, trucks, various commercial vehicles, watercraft including a variety of boats, ships, aircraft, and the like and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, in order to make the description of the present invention clear, unrelated parts are not shown and, the thicknesses of layers and regions are exaggerated for clarity. Further, when it is stated that a layer is “on” another layer or substrate, the layer may be directly on another layer or substrate or a third layer may be disposed therebetween.

An exemplary embodiment of the present invention will hereinafter be described in detail with reference to the accompanying drawings.

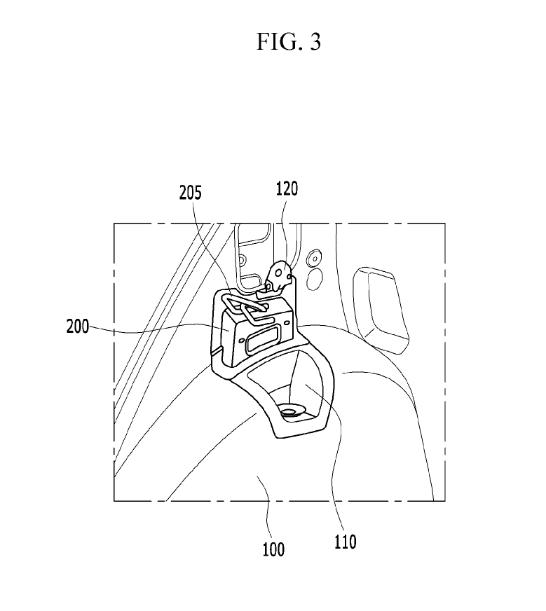

FIG. 3 is an exemplary partial perspective view of a vehicle body structure having a shock absorber mounting structure according to an exemplary embodiment of the present invention. Referring to FIG. 3, the vehicle body structure may include a vehicle body 100, a shock absorber mounting bracket 110, an interior MBR bracket 200, a seat striker 205, and a retractor bracket 120. In the vehicle body 100, a mounting aperture 320 mounted with the shock absorber mounting bracket 110 may be formed at a component that corresponds to a wheel house. The shock absorber mounting bracket 110 may adhere to the vehicle body 100 to close the mounting aperture 320.

Additionally, within the interior surface of the vehicle body 100, the interior MBR bracket 200 may be coupled to the upper side of the shock absorber mounting bracket 110, and the lower end portion of the interior MBR bracket 200 may be coupled to the vehicle body 100 to overlap the edge of the shock absorber mounting bracket 110. The interior MBR bracket 200 may form a space 330 of a cubic (e.g., square, rectangular or box) shape along with the vehicle body 100. Furthermore, the seat striker 205 may be coupled to the interior side of the interior MBR bracket 200, and the retractor bracket 120 may be coupled to the interior upper end portion the interior MBR of the bracket 200.

In an exemplary embodiment of the present invention, the interior MBR bracket 200 may be configured to transmit the load transmitted to the shock absorber mounting bracket 110 to the upper side of the vehicle body 100 and may form the space 330 of the cubic shape along with the vehicle body 100. In particular, the durability and the rigidity of the vehicle body 100 may be improved. Additionally, by directly joining the seat striker 205 and the retractor bracket 120 to the interior portion of the interior MBR bracket 200, the weight of the seat striker 205 and the retractor bracket 120 may be reduced. Moreover, the seat striker 205 and the retractor bracket 120 may be further fixed to the vehicle body 100 through the interior MBR bracket 200.

In an exemplary embodiment of the present invention, the striker may include a wire type having a predetermined exterior diameter and may be formed by bending a wire. A groove that corresponds to the exterior circumference of the striker may be formed on the exterior of the interior MBR bracket, and the striker may be bonded when mounted on the groove. Additionally, a plurality of portions of the striker may be bonded to the interior MBR bracket. Particularly, a first portion may be bonded to the upper side of the interior MBR bracket and a second portion may be bonded to the side of the interior surface of the interior MBR bracket.

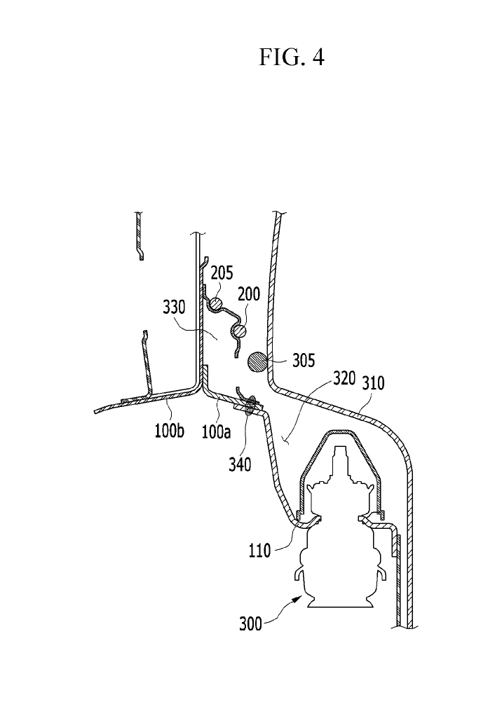

FIG. 4 is an exemplary partial view of a vehicle body structure that may include a shock absorber mounting structure according to an exemplary embodiment of the present invention. Referring to FIG. 4, the vehicle body 100 may include a first vehicle body member 100a and a second vehicle body member 100b. The first and second vehicle body 100 may be integrally formed in one, or may be bonded in the separation state.

In the first vehicle body member 100a, the mounting aperture 320 in which the shock absorber mounting bracket 110 may be disposed is formed. The interior side (e.g., right direction) of the space of the wheel house may be formed. The exterior end portion of the vehicle body of the first vehicle body member 100a may be bonded with the interior surface of the second vehicle body member 100b. The second vehicle body member 100b may extend from the exterior side (e.g., left side) to the interior side (e.g., right side) of the vehicle body and may extend in the upper side within the portion bonded to the first vehicle body member 100a.

In an exemplary embodiment of the present invention, the edge of the shock absorber mounting bracket 110 may be bonded along the mounting aperture 320 of the first vehicle body member 100a. The shock absorber 300 may be configured to be engaged from the lower portion to the upper portion while being penetrated in the center portion of the shock absorber mounting bracket 110. In particular, the upper surface of the exterior end portion of the vehicle body of the shock absorber mounting bracket 110 may be coupled to the lower surface of the first vehicle body member 100a, and the portion bent from the interior end portion of the vehicle body of the shock absorber mounting bracket 110 to the lower side may be coupled to the first vehicle body member 100a. The upper end portion of the interior MBR bracket 200 may be coupled with the interior surface of the second vehicle body member 100b. The lower end portion may be coupled to the upper surface of the first vehicle body member 100a, and an overlapping part 340 where the interior MBR bracket 200, the first vehicle body member 100a, and the shock absorber mounting bracket 110 overlap may be formed.

In an exemplary embodiment of the present invention, the impact energy transmitted to the shock absorber mounting bracket 110 through the shock absorber 300 may be transmitted to the overlapping component 340. Further, the impact energy transmitted to the overlapping component 340 may be dispersed through the second vehicle body member 100b and the interior MBR bracket 200, thereby improving the durability and the rigidity. Additionally, the weight and cost may be reduced by mounting the striker 205 to the interior MBR bracket 200 without an additional bracket or bolt. For example, referring to FIG. 3, in the part where the first vehicle body member 100a and the interior MBR bracket 200 are overlapped and coupled, the retractor bracket 120 may be bonded to the interior surface of the interior MBR bracket 200, and the durability and the rigidity may be increased. In an exemplary embodiment of the present invention, the space may be formed between the interior surface of the interior MBR bracket 200 and the exterior surface of the trim 310 and the wire 305 may pass through the space.

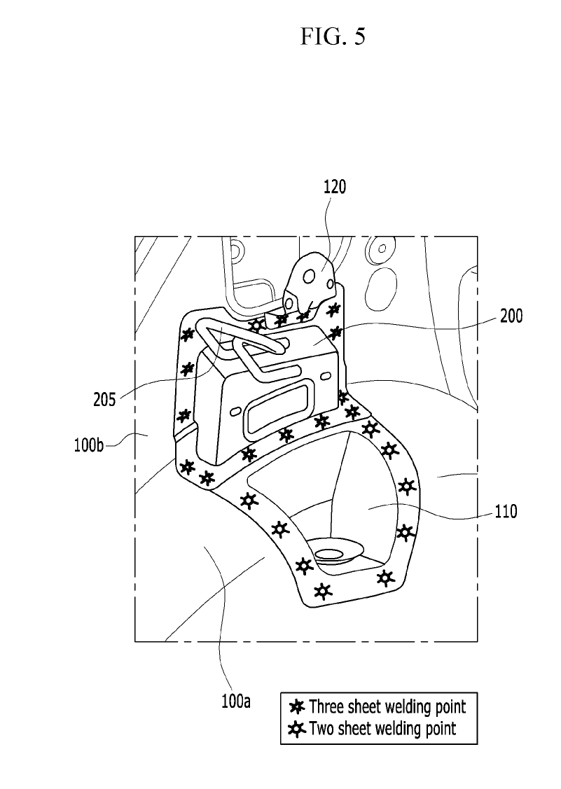

FIG. 5 is a partial view of a vehicle body structure having a shock absorber mounting structure according to an exemplary embodiment of the present invention. Referring to FIG. 5, a three sheet welding points and a two sheet welding points may be formed in the region where the vehicle body 100, the shock absorber mounting bracket 110, and the interior MBR bracket 200 are bonded to each other.

The three sheet welding point may be the portion where three plates are welded to each other, and two sheet welding point may be the portion where two plates are welded to each other. As shown, the three sheet welding point may be formed in the upper end portion of the bonding component of the vehicle body 100, the interior MBR bracket 200, and the shock absorber mounting bracket 110, thereby having the structure improved with the durability. In an exemplary embodiment of the present invention, the upper end portion of the interior MBR bracket 200 may be coupled to the interior surface of the second vehicle body member 100b, the lower end portion may be coupled to the upper surface of the second vehicle body member 100b, and both sides of the interior MBR bracket 200 may be coupled to the second vehicle body member 100b and the first vehicle body member 100a.

The lower end portion of the interior MBR bracket 200 may form the three sheet welding point along with the first vehicle body member 100a and the shock absorber mounting bracket 110. The upper end portion may form the two sheet welding point along with the second vehicle body member 100b, and both sides of the interior MBR bracket 200 may form the three sheet welding point along with an additional exterior MBR bracket (not shown by a reference numeral) disposed external to the first vehicle body member 100a and the first vehicle body member 100a.

While this invention has been described in connection with what is presently considered to be exemplary embodiments, it is to be understood that the invention is not limited to the disclosed exemplary embodiments, but, on the contrary, is intended to cover various modifications and equivalent arrangements included within the spirit and scope of the appended claims.

### DESCRIPTION OF SYMBOLS

100a: first vehicle body member
100b: second vehicle body member
100: vehicle body
105: reinforcement bracket
110: shock absorber mounting bracket
115: striker reinforcing member
120: retractor bracket
200: interior member (MBR) bracket
205: striker
300: shock absorber
305: wire
310: trim
320: mounting aperture
330: box space
340: overlapping component

What is claimed is:

1. A vehicle body structure having a shock absorber mounting structure, comprising:
a first vehicle body member formed with a mounting aperture that corresponds to a shock absorber of a suspension;
a shock absorber mounting bracket coupled to the first vehicle body member that corresponds to the mounting aperture and has one side configured to engage the upper end portion of the shock absorber while being penetrated;
a second vehicle body member coupled to the exterior edge portion of the first vehicle body member and extends within the upper side; and
an interior member (MBR) bracket having a first side coupled to the interior surface of the second vehicle body member and a second side coupled to the upper surface of the first vehicle body member and forms a cross-sectional box space with the first and second vehicle body members.

2. The vehicle body structure of claim 1, wherein a striker connected to a seat is bonded to the exterior surface of the interior MBR bracket.

3. The vehicle body structure of claim 2, wherein the striker is a wire type of a circular cross sectional with a predetermined exterior diameter.

4. The vehicle body structure of claim 2, wherein a groove that corresponds to the exterior circumference of the striker is formed on the exterior of the interior MBR bracket and a portion of the striker is inserted within the groove.

5. The vehicle body structure of claim 2, wherein, a first portion of the striker is coupled to the upper side of the interior MBR bracket and a second portion of the striker is coupled to the interior surface side of the interior MBR bracket.

6. The vehicle body structure of claim 2, wherein the exterior surface is coupled with the interior surface of the second vehicle body member within the upper side of the interior MBR bracket, and the interior surface is coupled with the retractor bracket connected to the safety belt.

7. The vehicle body structure of claim 2, wherein:
the lower end portion of the interior MBR bracket is bent within the vehicle body and the upper surface of the first vehicle body member is coupled to the lower end portion,
the upper surface exterior of the vehicle body of the shock absorber mounting bracket is bonded to the lower surface of the first vehicle body member and a plurality of members of the interior MBR bracket, the first vehicle body member, and the shock absorber mounting bracket are overlapped and bonded.
